(19) United States
(12) Patent Application Publication
(10) Pub. No.: US 2010/0097357 A1
(43) Pub. Date: Apr. 22, 2010

(54) COMPUTER AND METHOD FOR CONTROLLING EXTERNAL DISPLAY DEVICE

(75) Inventor: Wei-Po Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/575,477

(22) Filed: Oct. 8, 2009

(30) Foreign Application Priority Data
Oct. 22, 2008 (TW) 97140496

(51) Int. Cl. G09G 5/00

(52) U.S. Cl. 345/204

(57) ABSTRACT

A computer has a hardware layer module, a driver layer module, and an application layer module. The hardware layer module has a number of interface ports, and a preset interface port of the interface ports is coupled with the external display device. When the external display device is coupled to the hardware layer module via the preset interface port, the driver layer module outputs a notify message to the application layer module and controls the hardware layer module to read hardware information of the external display device. In addition, upon receiving the notify message, the application layer module can read the hardware information from the hardware layer module via the driver layer module and control the driver layer module to provide multiple displaying modes to the hardware layer module according to the hardware information. Thus, the external display device is enabled to display a video in a suitable displaying mode.

### CROSS-REFERENCE TO RELATED APPLICATION

This application claims the priority benefit of Taiwan application serial no. 97140496, filed on Oct. 22, 2008. The entirety of the above-mentioned patent application is hereby incorporated by reference herein and made a part of specification.

### BACKGROUND OF THE INVENTION

1. Field of the Invention

The present invention generally relates to control of a display, and more particularly, to control of an external display connected to a computer.

2. Description of Related Art

A personal computer host typically includes many input/output interface ports.

For example, the compute host may include a digital visual interface (DVI) port which is a standard video interface port. A display can generally be connected to the computer host via the DVI interface port and serves as an output unit of the computer.

In addition to the personal computer, currently many notebook computers are also equipped with the DVI port as a standard hardware device. The notebook computer usually has a built-in computer screen but the built-in screen is too small. If in a presentation-making environment, the video on the built-in screen needs to be displayed through an external display device, such as, through a projector to project the video. As a result, the notebook computer may need the DVI port for coupling with the external display device.

When the user needs to use the external display device to display the video on the notebook computer, the user conventionally needs to connect the external display device to the DVI port of the notebook computer and subsequently uses a hotkey on the notebook computer to switch the device for displaying the video. The function of driving the external display to display the video is conventionally achieved by a VGA basic input/output system (VGA BIOS) which controls a VGA chip to control the external display device.

However, due to the limited size of the notebook computer screen, if the video on the built-in screen is directly displayed by the external display device, the video displayed by the external display may be too small. If the size of the video being displayed by the external display device is directly enlarged, the resolution of the video is decreased. This problem may be more serious for a notebook computer with a small sized screen.

### SUMMARY OF THE INVENTION

Accordingly, the present invention is directed to a computer which is capable of automatic selection of a displaying mode based on a state of an external display device.

The present invention also provides a method for controlling an external display device which can automatically detect whether the external display device is coupled to a computer and select a suitable displaying mode for the external display device to display a video.

The present invention provides a computer including a hardware layer module, a driver layer module, and an application layer module. The hardware layer module includes a plurality of interface ports and a preset interface port of the plurality of interface ports is used for coupling with an external display device. When the external display device is coupled to the hardware layer module via the preset interface port, the driver layer module outputs a notify message to the application layer module and controls the hardware layer module to read hardware information of the external display device. In addition, upon receiving the notify message, the application layer module can read the hardware information from the hardware layer module via the driver layer module and control the driver layer module to provide multiple displaying modes to the hardware layer module according to the hardware information. Thus, the external display device is enabled to display a video in a suitable displaying mode.

In another aspect, the present invention provides a method for controlling an external display device which is suitable for use in a computer. The control method includes providing multiple displaying modes. When the external display device is coupled to the computer, hardware information of the external display device is read.

Thus, one of the displaying modes can be selected for the external display device to display a video based on the read hardware information.

In another aspect, the present invention provides a computer including a preset interface port, a detection circuit, a controller, a driver module, and a screen adjustment module. The preset interface port is adapted for coupling with an external display device and is coupled to the detection circuit. The detection circuit can generate a corresponding detection output signal outputted to the controller according to a state of the preset interface port. The controller generates a corresponding control signal outputted to the driver module according to a state of the detection output signal. Thus, the driver module can determine whether to output extended display identification data to the screen adjustment module according to the control signal. The screen adjustment module is used to decide the resolution of a video to be displayed. When the driver module outputs the extended display identification data, the screen adjustment module adjusts the video so as to be displayed on the external display device in an extended mode.

When the external display device is coupled to the computer, multiple displaying modes can be provided such that the external display device can display a video in a suitable displaying mode. Therefore, only simple user manipulation is needed to enable the external display to operate better in various environments.

In order to make the aforementioned and other features and advantages of the present invention more comprehensible, embodiments accompanied with figures are described in detail below.

### BRIEF DESCRIPTION OF THE DRAWINGS

FIG. 1 illustrates an external display device connected to a computer.

FIG. 2 illustrates a block diagram of a computer system according to a preferred embodiment of the present invention.

FIG. 3 is a block diagram of a physical circuit for controlling the external display device according to a preferred embodiment of the present invention.

FIG. 4 is a flow chart of a method for controlling the external display device according to a preferred embodiment of the present invention.

FIG. 5 illustrates a pin arrangement of a DVI interface port.

FIG. 6 is a block diagram of a detection circuit according to a preferred embodiment of the present invention.

### DESCRIPTION OF THE EMBODIMENTS

### First Embodiment

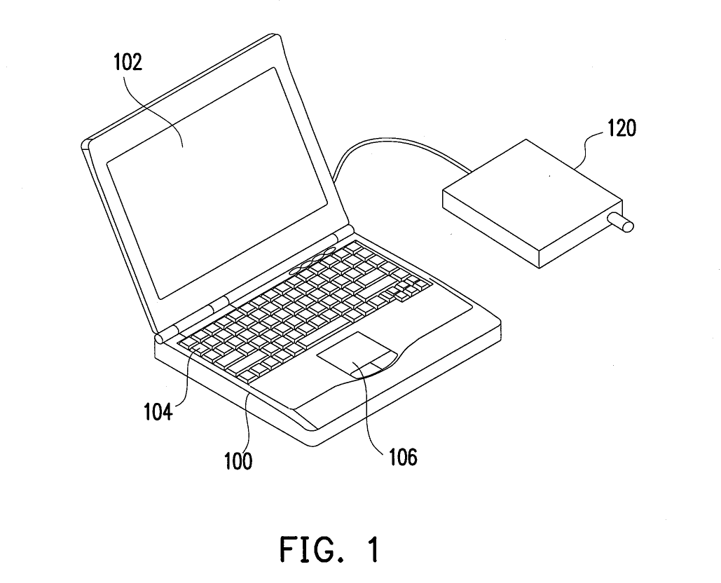

FIG. 1 illustrates an external display device connected to a computer. As shown in FIG. 1, the computer 100 of the present embodiment may be a notebook computer and the external display device 120 may be a projector, for example. However, it should be understood that the computer 100 is not intended to be limited to the notebook computer and the external display device 120 is not intended to be limited to the projector. Rather, the external display device 120 could be implemented as other displays in alternative embodiments, such as, a liquid crystal display or a cathode ray tube display.

As shown in FIG. 1, physically (i.e., viewed from a hardware layer), the computer 100 at least includes an input unit such as a keyboard 104 or a touch panel 106. In addition, the computer 100 also includes a built-in output unit such as a screen 102. It should be understood that the computer 100 can also include a plurality of interface ports for connection of external electronic devices. However, these interface ports are not illustrated in FIG. 1 because they are disposed on another side of the computer 100 that is invisible from the present aspect.

It is well known that different interface ports can be used to transmit different signals. A preset interface port for transmitting video signals can be a digital visual interface (DVI) port and a user can couple the external display device 120 to the computer 100 via a DVI plug. Thus, the computer 100 can control the external display device 120 to output a video.

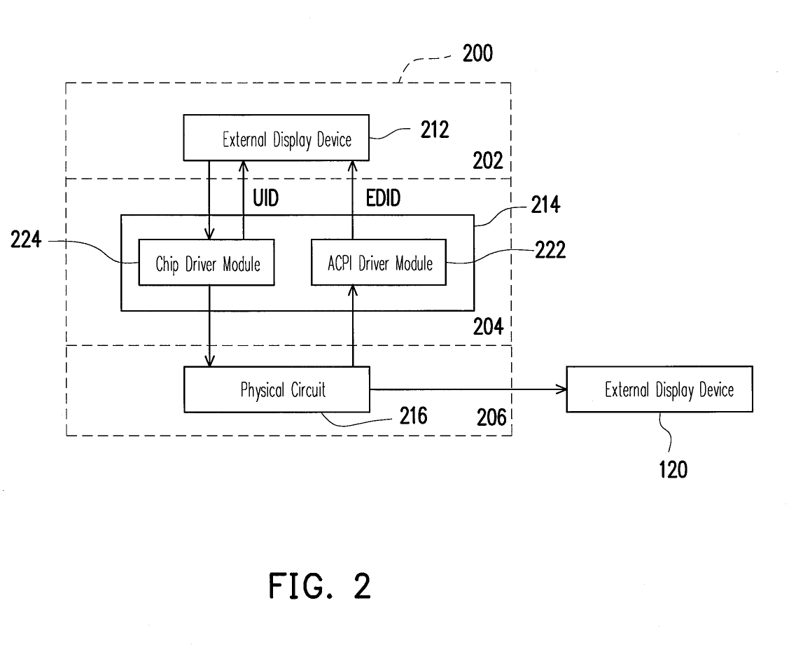

FIG. 2 illustrates a block diagram of a computer system according to a preferred embodiment of the present invention. As shown in FIG. 2, the computer 200 of the present embodiment includes an application layer 202, a driver layer 204, and a hardware layer 206. The application layer module 202 includes a screen adjustment module 212 that can receive a user input and is coupled to the driver layer 204. The driver layer 204 includes a driver module 214. The driver module 214 includes an advanced configuration and power interface (ACPI) driver module 222 coupled to the hardware layer 206 and a chip driver module 224 coupled to the screen adjustment module 212 of the application layer 202. In addition, the hardware layer 206 may include a physical circuit 216 such as a motherboard circuit and various components shown in FIG. 1.

The application layer 202 and the driver layer 204 can generally be implemented by software installed in the operating system of the computer 200. In other words, the screen adjustment module 212 can be implemented by an application program that can process information inputted by the user. Similarly, the ACPI driver module 222 and the chip driver module 224 may also be implemented by driver programs. In some embodiments, the driver layer 204 can be located in the kernel of the operating system, for driving the physical circuit 216 in the hardware layer 206.

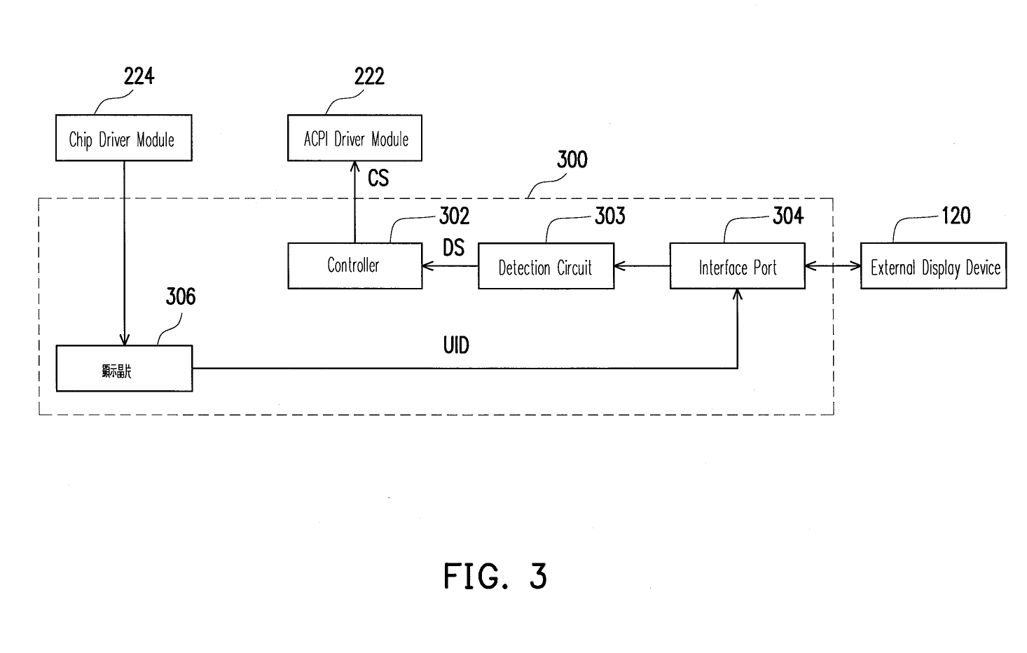

FIG. 3 is a block diagram of a physical circuit for controlling the external display device according to a preferred embodiment of the present invention. As shown in FIG. 3, the physical circuit 300 of the present embodiment may include a controller 302, a detection circuit 303, an interface port 304 and a display chip 306. The controller 302 can be coupled to the ACPI driver module 222 and the detection circuit 303. The detection circuit 303 can be coupled to the interface port 304. In addition, the display chip 306 can also be coupled to the interface port 304 and the chip driver module 224. In the present embodiment, the controller 302 may be implemented as an embedded controller and the display chip 306 may be implemented as a VGA display chip.

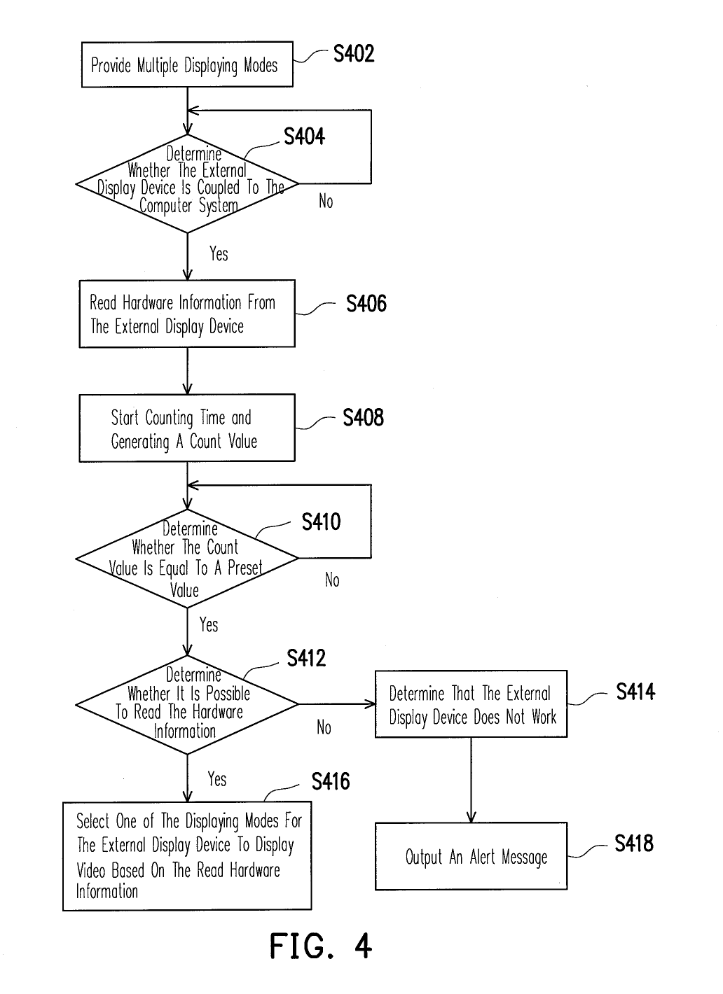

FIG. 4 is a flow chart of a method for controlling the external display device according to a preferred embodiment of the present invention. Referring to FIGS. 2, 3, and 4, in the present embodiment, the screen adjustment module 212 may provide a plurality of displaying modes at step S402. In some embodiments, these displaying modes include a clone mode and an extended mode. In addition, the detection circuit 303 may determine if the external display 120 is coupled to the computer 200 at step S404.

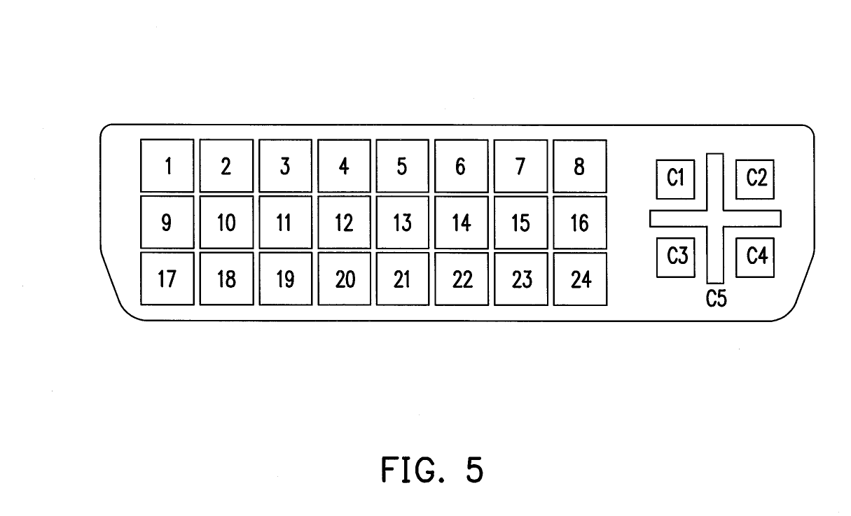

In the present embodiment, the detection circuit 303 may detect states of pins of the interface port 304 to detect if the external display device 120 is coupled to the computer 200. FIG. 5 illustrates a pin arrangement of a DVI interface port. As shown in FIG. 5, assuming the interface port 304 is a DVI interface, the interface port 304 can include pin 1-pin 24 and pin C1-pin C5. When the external display 120 is connected to the interface port 304 via a DVI plug, at least part of the pins shown in FIG. 5 are changed in voltage level. Therefore, the controller 302 can determine if the external display 120 is coupled to the computer 200 by detecting the voltage level of these pins.

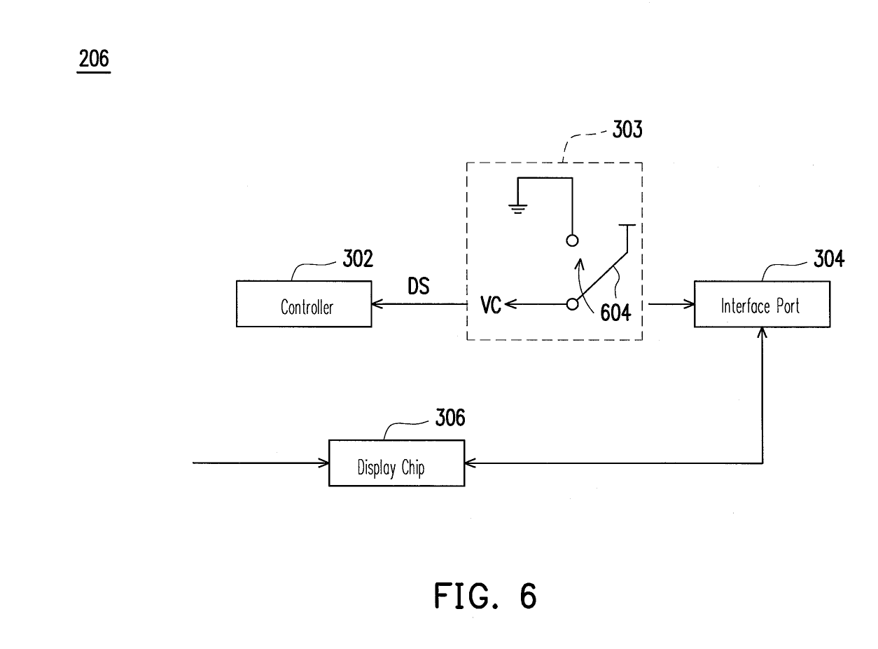

FIG. 6 is a block diagram of a detection circuit according to a preferred embodiment of the present invention. As shown in FIG. 6, the detection circuit 303 may be implemented by an electrical circuit or combined mechanism. In the present embodiment, the detection circuit 303 may be provided with a spring tab 604. One end of the spring tab 604 may be disposed at the interface port 304, and the other end of the spring tab 604 may be coupled to a power supply Vc when the external display 120 is not coupled to the interface port 304. As such, when the external display 120 is not coupled to the interface port 304, the voltage level of a detection output signal DS generated by the detection circuit 303 may be Vc or another voltage level. On the other hand, when the external display 120 is coupled to the interface port 304 via the plug, the spring tab 303 is pushed causing the spring tab 604 to switch from being coupled to one end of the power supply Vc to being grounded. At this time, the voltage level of the detection output signal DS generated by the detection circuit 303 may be the ground level.

Referring again to FIGS. 2, 3, and 4, before the external display device 120 is coupled to the computer 200 (i.e., “No” as indicated in step S404), as described above, the detection circuit 303 may output an detection output signal of a first state to the controller 302. At this time, the controller 302 also generates a corresponding control signal to the ACPI driver module 222. The ACPI driver module 222 may in turn notify the screen adjustment module 212 to maintain the output video generated by the computer 200 in its original state.

On the other hand, when the plug of the external display device 120 is coupled to the interface port 304 (i.e., “Yes” as indicated in step S404), the detection circuit 303 may output a detection output signal of a second state to the controller 302, causing the controller 302 to output a corresponding control signal CS to the ACPI driver module 222. At this time, the driver layer module 222 may output a notify message and extended display identification data EDID to the screen adjustment module 212. At this time, the screen adjustment module may control the chip driver module 224 to instruct the display chip 306 to execute step S406, i.e., read hardware information UID of the external display device 120 via the interface port 304.

In some alternative embodiments, when the display chip 306 is instructed to read the hardware information UID of the external display device 120 via the interface port 304, the chip driver module 224 may also start a time counting and generate a count value at step S408. Next, at step S410, the chip driver module 224 may determine if the count value is equal to a preset value. If the count value is not equal to the preset value yet (i.e., “No” as indicated in step S410), the time counting continues. When the count value is equal to the preset value (i.e., “Yes” as indicated in step S410), the chip driver module 204 may, at step S412, determine if the display chip 306 can successfully read the hardware information UID from the external display device 120.

If the display chip 306 cannot read the hardware information UID from the external display 120 yet by the time the count value reaches the preset value (i.e., “No” as indicated in step S412), the chip driver module 224 may notify the screen adjustment module 212. At this time, the screen adjustment module 212 may determine that the external display 120 works abnormally at step S414. In some alternative embodiments, the screen adjustment module 212 may also output an alert message. For example, the built-in display displays a text message to advise the user.

On the contrary, when the display driver 306 has successfully read the hardware information UID from the external display device 120 (i.e., “Yes” as indicated in step S412) before the count value reaches the preset value, the display chip 306 may transmit the hardware information UID to the chip driver module 224 which, in turn, may transmit the received hardware information UID to the screen adjustment module 212. At step S416, upon receiving the hardware information UID, the screen adjustment module 212 can determine the type of the external display device 120 and control the chip driver layer module 204 to drive the display chip 306 to select one of the displaying modes for the external display device 120 to display a video.

Assuming the external display device 120 is a projector, the screen adjustment module 212 may control the chip driver module 224 to drive the display chip 306 such that the external display device 120 displays a video in an extended mode according to the EDID generated by the ACPI driver module 222. In the present embodiment, the extended mode used herein is such that the video image originally displayed on the built-in display of the computer 200 is enlarged to fit the external display device 120, with the resolution being increased simultaneously such that distortion of the image displayed by the external display 120 is mitigated. In addition, the screen adjustment module 212 may also control the chip driver module 224 to drive the display chip 306 to enable the external display 120 to display the video in a clone mode in response to a user manipulation. The clone mode used herein is such that the video image displayed on the built-in screen of the computer 200 is displayed on the external display at its original size.

In addition, the computer 200 may be provided with a plurality of function keys. Therefore, the application layer module 202 may also control the driver layer module 204 to switch the displaying mode of the external display device 120 according to a user input. Besides, the user may also manipulate the function keys of the computer 200 to control the computer 200 to select the following displaying modes: displaying video only by the built-in display, display video only by the external display device 120, or display video simultaneously by the built-in display and the external display device 120.

In summary, the present invention may determine if the external display device works according to whether the hardware information of the external display has been read within a preset time. Therefore, the present invention can save the time for the user to debug. In addition, the present invention can select a displaying mode suitable for the external display device to display a video. Therefore, the user's operation can be simplified which increases the convenience of using the computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer adapted for coupling with an external display device, comprising:
a hardware layer module comprising a plurality of interface ports, a preset interface port of the plurality of interface ports adapted for coupling with the external display device;
a driver layer module coupled to the hardware layer module, when the external display device is coupled to the hardware layer module via the preset interface port, the driver layer module outputs a notify message and controls the hardware layer module to read hardware information of the external display device; and
an application layer module coupled to the driver module, for reading the hardware information from the hardware layer module via the driver layer module as receiving the notify message, and controlling the driver layer module to provide multiple displaying modes to the hardware layer module according to the hardware information, so as to enable the external display device to display a video in one of the displaying modes.

2. The computer according to claim 1, wherein the application layer module further receives a user input, so that the application layer module controls the driver layer module to drive the hardware layer module according to the user input so as to cause the external display device to switch the displaying mode for displaying the video.

3. The computer according to claim 1, wherein the hardware layer module further comprises:
a controller coupled to the preset interface port for determining whether or not the external display device is coupled to the hardware layer module; and
a display chip coupled to the driver layer module and the preset interface port for controlling the external display device to display the video in one of the displaying modes.

4. The computer according to claim 3, wherein the hardware layer module further comprises a detection circuit coupled to the preset interface port and the controller, and having an output which is in a first state when the external display device is not coupled to the preset interface port, and a second state when the external display device is coupled to the preset interface port.

5. The computer according to claim 3, wherein the display chip reads the hardware information when the external display device is coupled to the preset interface port.

6. The computer according to claim 1, wherein the preset interface port is a digital visual interface port.

7. The computer according to claim 1, wherein the external display device is a projector or display.

8. The computer according to claim 1, wherein the application layer module outputs an alert message when the application layer module fails to read the hardware information within a preset time period after receiving the notify message.

9. The computer according to claim 1, wherein the displaying modes comprise a clone mode and an extended mode.

10. A method for controlling an external display device, adapted for use in a computer, the method comprising:
providing multiple displaying modes;
reading hardware information of the external display device when the external display device is coupled to the computer; and
selecting one of the displaying modes based on the hardware information and causing the display device to display a video in the selected displaying mode.

11. The method according to claim 10, after reading the hardware information, further comprising:
starting counting time and generating a count value;
determining whether or not the hardware information can be correctly read from the external display device when the count value is equal to a preset value;
determining that the external display device works abnormally when the hardware information cannot be correctly read from the external display device; and
causing the external display device to display the video when the hardware information can be read from the external display device.

12. The method according to claim 11, further comprising outputting an alert message when it is determined that the external display device works abnormally

13. The method according to claim 12, wherein outputting the alert message comprises causing a built-in display of the computer to display a text message.

14. The method according to claim 10, further comprising, in response to a user input, selecting different displaying modes for the external display device to display the video.

15. The method according to claim 12, wherein the displaying modes comprise a clone mode and an extended mode.

16. The method according to claim 12, further comprising providing a driver program in an operating system of the computer to drive the external display device to display the video in the selected displaying mode.

17. A computer, comprising:
a preset interface coupled to an external display device;
a detection circuit coupled to the preset interface port and adapted for detecting a state of the preset interface port and generating a corresponding detection output signal;
a controller coupled to the detection circuit for generating a corresponding control signal according to the state of the detection output signal;
a driver module coupled to the controller for determining whether or not to output extended display identification data according to the control signal; and
a screen adjustment module coupled to the driver module for adjusting the resolution of a video to be displayed on the external display device when the driver module outputs the extended display identification data.

18. The method according to claim 17, further comprising a display chip coupled to the driver module and the preset interface port, wherein the display chip is adapted for receiving the video with the adjusted resolution and transmitting the video through the interface port to the external display device for displaying.

19. The method according to claim 18, wherein the driver module comprises:
an advanced configuration and power interface driver module coupled to the controller for generating a corresponding output provided to the screen adjustment module according to the control signal; and
a chip driver module coupled to the screen adjustment module and the display chip for reading hardware information of the external display device and transmitting the hardware information to the screen adjustment module via the display chip, the chip driver module also adapted for transmitting a video processed by the screen adjustment module to the display chip.

20. The method according to claim 17, wherein the preset interface port is a digital visual interface port.
